(19) United States
(12) Patent Application Publication
(10) Pub. No.: US 2026/0121157 A1
(43) Pub. Date: Apr. 30, 2026

(54) MULTI-FUNCTION BATTERY PACK MODULE WITH END PLATE RECEIVER

(71) Applicant: FCA US LLC, Auburn Hills, MI (US)

(72) Inventor: Zachary E Cook, Auburn Hills, MI (US)

(21) Appl. No.: 18/929,861

(22) Filed: Oct. 29, 2024

(51) Int. Cl. H01M 10/6556; H01M 10/613; H01M 10/625; H01M 10/6567; H01M 50/264; H01M 50/271

(52) U.S. Cl. CPC H01M 10/6556; H01M 10/6567; H01M 50/264; H01M 50/271; H01M 10/613; H01M 10/625

(57) ABSTRACT

A battery module for a battery pack assembly of an electric vehicle includes a housing having an interior configured to house a plurality of battery cells. First and second opposed end plates each include a receiving aperture fluidly coupled to the housing interior and configured to fit over and receive a cooling/mounting connector of the battery pack assembly to facilitate a quick-connect coupling to the battery pack assembly. The first end plate receiving aperture is configured to receive a flow of coolant from a coolant passage in a first cooling/mounting connector and provide the coolant flow to the housing interior for cooling of the plurality of battery cells. The second end plate receiving aperture is configured to receive the flow of coolant from the housing interior and provide the flow of coolant to a coolant passage in a second cooling/mounting connector.

### FIELD

The present application relates generally to electrified vehicles and, more particularly, to a modular battery pack module connector system for electrified vehicles.

### BACKGROUND

An electrified vehicle (hybrid electric, plug-in hybrid electric, range-extended electric, battery electric, etc.) includes a high voltage battery system with a battery pack assembly utilized to power at least one electric motor. Conventional battery pack assemblies include a plurality of battery modules filled with cells that rest on top of multiple cooling plates to remove heat from the battery modules for optimal operating temperature. However, this requires a complex secondary cooling system routed throughout the battery pack, including many hoses and fluid connections that must be sub-assembled and may be susceptible to leaking. The battery modules must also be fastened within the battery pack assembly. As such, the amount of cooling hoses, fluid connections, and fasteners increase as the size of the battery pack increases, creating complexity during assembly and service. Accordingly, while such conventional electrified vehicle battery systems work well for their intended purpose, there exists an opportunity for improvement in the relevant art.

### SUMMARY

In accordance with one example aspect of the invention, a battery module for a battery pack assembly of an electric vehicle is provided. In one exemplary implementation, the battery module includes a housing having an interior configured to house a plurality of battery cells, and first and second opposed end plates each having a receiving aperture fluidly coupled to the housing interior and configured to fit over and receive a cooling/mounting connector of the battery pack assembly to facilitate a quick-connect coupling to the battery pack assembly. The first end plate receiving aperture is configured to receive a flow of coolant from a coolant passage in a first cooling/mounting connector and provide the coolant flow to the housing interior for cooling of the plurality of battery cells. The second end plate receiving aperture is configured to receive the flow of coolant from the housing interior and provide the flow of coolant to a coolant passage in a second cooling/mounting connector.

In addition to the foregoing, the described battery module may include one or more of the following features: wherein the battery module is coupled to the battery pack assembly via the first and second cooling/mounting connectors such that the battery module does not require any fasteners to further secure the battery module to the battery pack assembly; wherein the receiving aperture has a complimentary size and shape to the cooling/mounting connector to provide an interference fit between the first or second end plate and the cooling/mounting connector; and wherein coolant supplied to the housing interior immerses the plurality of battery cells for cooling thereof.

In addition to the foregoing, the described battery module may include one or more of the following features: wherein each of the first and second end plates further includes a tapering aperture configured to receive or supply the flow of coolant from or to the cooling/mounting connector; wherein each of the first and second end plates further includes a supply/outlet passage fluidly coupled between the tapering aperture and the housing interior to supply the flow of coolant therebetween; wherein the first end plate comprises a set of two receiving apertures configured to each receive one cooling/mounting connector; wherein the second end plate comprises a set of two receiving apertures configured to each receive one cooling/mounting connector; wherein the housing comprises a bottom wall, opposed sidewalls, a top cover, and the end plates to define the housing interior; and wherein at least one of the first and second end plates includes electric terminals.

In accordance with another example aspect of the invention, an electrified vehicle is provided. In one exemplary implementation, the vehicle includes an electric traction motor and a high voltage battery system configured to power the electric traction motor and including a high voltage battery pack assembly with at least one battery module. The at least one battery module includes a housing having an interior configured to house a plurality of battery cells, and first and second opposed end plates each having a receiving aperture fluidly coupled to the housing interior and configured to fit over and receive a cooling/mounting connector of the battery pack assembly to facilitate a quick-connect coupling to the battery pack assembly. The first end plate receiving aperture is configured to receive a flow of coolant from a coolant passage in a first cooling/mounting connector and provide the coolant flow to the housing interior for cooling of the plurality of battery cells. The second end plate receiving aperture is configured to receive the flow of coolant from the housing interior and provide the flow of coolant to a coolant passage in a second cooling/mounting connector.

In addition to the foregoing, the described electrified vehicle may include one or more of the following features: wherein the battery module is coupled to the battery pack assembly via the first and second cooling/mounting connectors such that the battery module does not require any fasteners to further secure the battery module to the battery pack assembly; wherein the receiving aperture has a complimentary size and shape to the cooling/mounting connector to provide an interference fit between the first or second end plate and the cooling/mounting connector; and wherein coolant supplied to the housing interior immerses the plurality of battery cells for cooling thereof.

In addition to the foregoing, the described electrified vehicle may include one or more of the following features: wherein each of the first and second end plates further includes a tapering aperture configured to receive or supply the flow of coolant from or to the cooling/mounting connector; wherein each of the first and second end plates further includes a supply/outlet passage fluidly coupled between the tapering aperture and the housing interior to supply the flow of coolant therebetween; and wherein the first end plate comprises a set of two receiving apertures configured to each receive one cooling/mounting connector.

In addition to the foregoing, the described electrified vehicle may include one or more of the following features: wherein the second end plate comprises a set of two receiving apertures configured to each receive one cooling/mounting connector; wherein the housing comprises a bottom wall, opposed sidewalls, a top cover, and the end plates to define the housing interior; and wherein at least one of the first and second end plates includes electric terminals.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a functional block diagram of an example electrified vehicle having a battery pack assembly in accordance with the principles of the present application;

FIG. 2 is a perspective view of an example high voltage battery pack assembly of the vehicle shown in FIG. 1, in accordance with the principles of the present application;

FIG. 3 is a side view of the high voltage battery pack assembly shown in FIG. 2, in accordance with the principles of the present application;

FIG. 4 is a sectional view of a portion of the high voltage battery assembly shown in FIG. 2, in accordance with the principles of the present application;

FIG. 5 is a side view of an example cooling/mounting connector of the battery pack assembly shown in FIGS. 2-4, in accordance with the principles of the present application; and

FIG. 6 is a side view of a portion of the high voltage battery pack assembly shown in FIG. 2, in accordance with the principles of the present application.

### DETAILED DESCRIPTION

As previously discussed, conventional battery pack assemblies have complex cooling systems with multiple hoses, cooling plates, and fluid connections. Moreover, many fasteners are required to couple individual battery modules to the battery pack assembly. Accordingly, systems and methods are provided herein for a multi-function battery module connector system for both cooling and mounting. The connectors provide mounting, fixation, and isolation for the individual battery modules, as well as provide a cooling passage to the battery module. The battery module connectors enable streamlined assembly and service, reduce complexity due to reduced component count, and lower cost by removing additional plastic hosing, manifolds, fasteners, and redundant structural elements within the battery pack assembly.

In one example, a high voltage (HV) battery pack assembly includes extruded supports configured to support a plurality of the battery modules. The module connectors are disposed along the supports to quickly fasten and secure the battery modules to the supports. The module connectors are also fluidly coupled to coolant passages in the extruded support to provide coolant distribution through each battery module. Accordingly, the multi-function module connectors provide both mounting and cooling functionality by implementing battery module cooling, structural fixation, and isolation into one component as opposed to separate unique systems that require additional subassembly and increased assembly complexity.

The cooling/mounting connectors are directly attached to a unique aluminum extrusion that provides battery module structure support and mounting/fixation. A liquid-tight seal to the connector allows fluid to flow from the extrusion through the connectors, and into the battery module to cool battery cells. The connectors include elastomeric (e.g., rubber) isolation properties to reduce noise, vibration, harshness (NVH) related to the cooling system and support structure of the battery modules. In this way, the connectors include isolation properties mimicking those of body mounts for body-on-frame vehicles to minimize vibration/loads into the battery module. The connectors enable the battery module to be quickly and easily placed into position and secured to the extrusion without the need for fasteners.

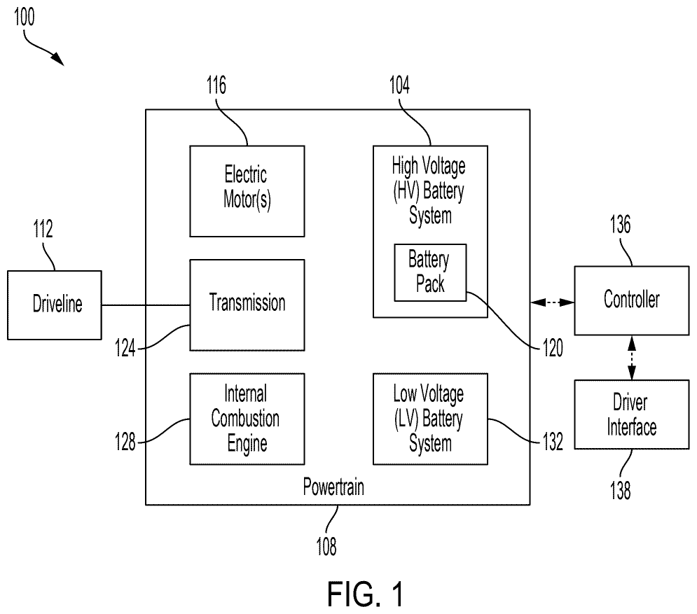

With initial reference to FIG. 1, a functional block diagram of an electrified vehicle 100 having an example high voltage (HV) battery system 104 according to the principles of the present application is illustrated. The electrified vehicle 100 could be any suitable type of electrified vehicle, including, but not limited to, a battery electric vehicle (BEV) or a plug-in hybrid electric vehicle (PHEV). The electrified vehicle 100 comprises an electrified powertrain 108 configured to generate and transfer drive torque to a driveline 112 for vehicle propulsion. The electrified powertrain 108 includes one or more electric traction motors 116 each configured to generate mechanical drive torque using energy (e.g., electrical current) supplied by the high voltage battery system 104, which includes a HV battery pack assembly 120. For example, an inverter (not shown) could be used to convert the direct current (DC) from the high voltage battery system 104 to three-phase alternating current (AC) to power the electric traction motor(s) 116. A transmission 124 (e.g., an automatic transmission) is configured to transfer the drive torque from the electrified powertrain 108 to the driveline 112.

The electrified powertrain 108 also includes an optional internal combustion engine 128 configured to combust a mixture of air and fuel (gasoline, diesel, etc.) to generate mechanical torque for vehicle propulsion and/or conversion to electrical energy, such as for battery system recharging. A low voltage battery system 132 (e.g., a 12-volt (V) battery) is configured to power low voltage components and accessory loads of the electrified vehicle 100. A controller 136 is configured to control the electrified powertrain 108, including controlling the electrified powertrain to generate an amount of drive torque to satisfy a torque request provided by a driver/operator via a driver interface 138 (e.g., an accelerator pedal).

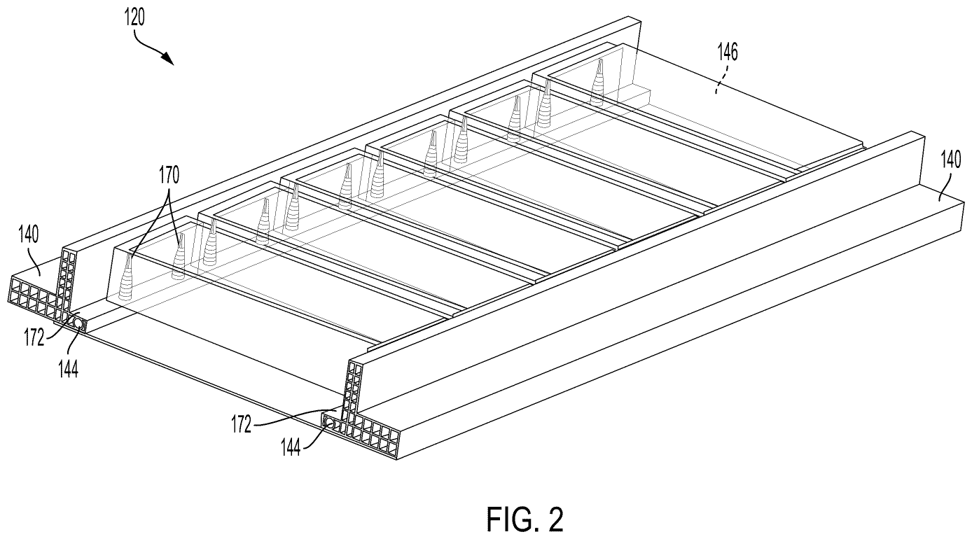

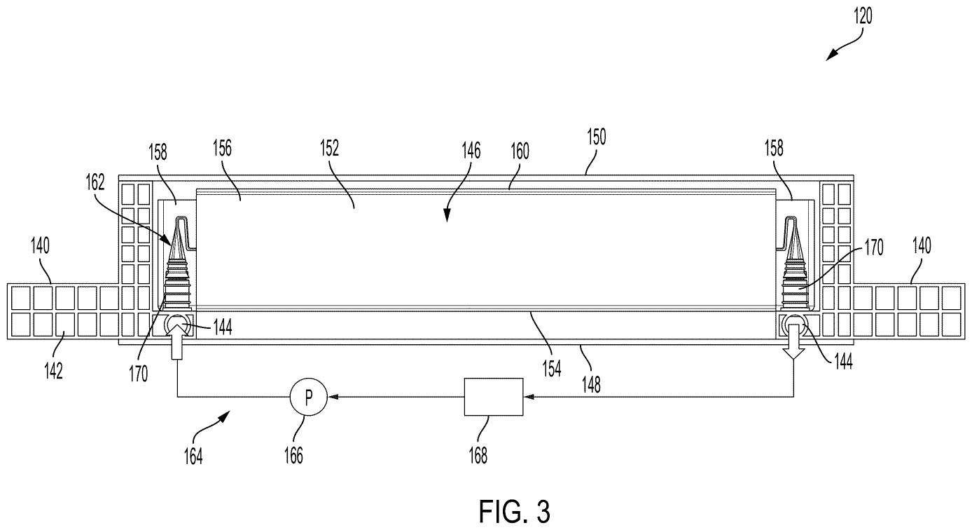

With reference now to FIGS. 2 and 3, additional features of the battery pack assembly 120 will be described in more detail. The battery pack assembly 120 generally includes a pair of opposed side supports 140 configured to couple to the vehicle (e.g., frame, body, etc.). In the example embodiment, the supports 140 are a rigid extruded material such as, for example, aluminum. It will be appreciated that supports 140 may be fabricated in any suitable manner, such as casting, molding, 3D printing, etc. In the example embodiment, the supports 140 are formed with various channels/passages 142 to reduce material, improve structural rigidity, and/or absorb force from impact events (e.g., collapsible passages). The supports 140 are also formed with integral coolant passages 144 configured to receive a flow of coolant, as described herein in more detail.

As shown in FIG. 3, the opposed supports 140 are configured to receive and support one or more battery modules 146, which may be enclosed within the battery pack assembly 120 by the supports 140, a bottom wall 148, a top wall 150, and end plates (not shown) disposed at the opposed ends of the supports 140.

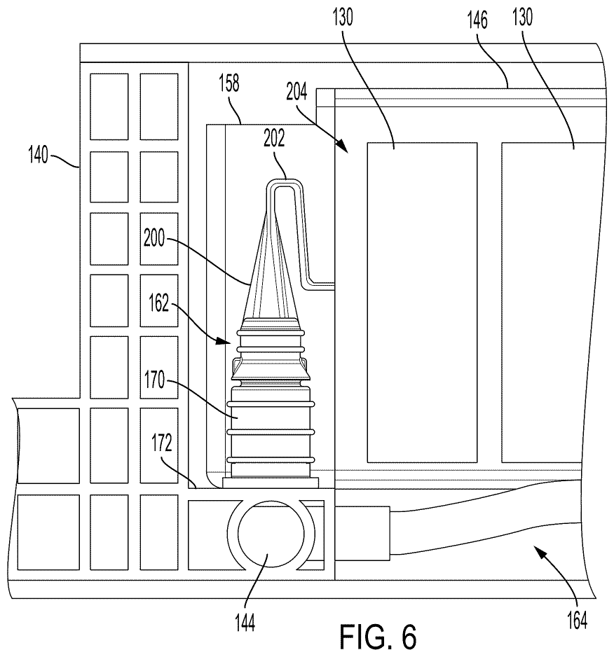

In the example embodiment, as shown in FIGS. 2 and 3, each battery module 146 generally includes a housing 152 configured to house a plurality of battery cells 130 (FIG. 6). The module housing 152 can be formed of aluminum and generally includes a bottom wall 154, opposed sidewalls 156, opposed end plates 158, and a top lid or cover 160. One or both of the end plates 158 define electrical terminals (not shown) for connecting each battery module 146 to the vehicle HV electrical system. As shown in FIG. 3, the end plates 158 include one or more receiving apertures or ports 162 configured to fit over and receive a cooling/mounting connector 170, as described herein in more detail.

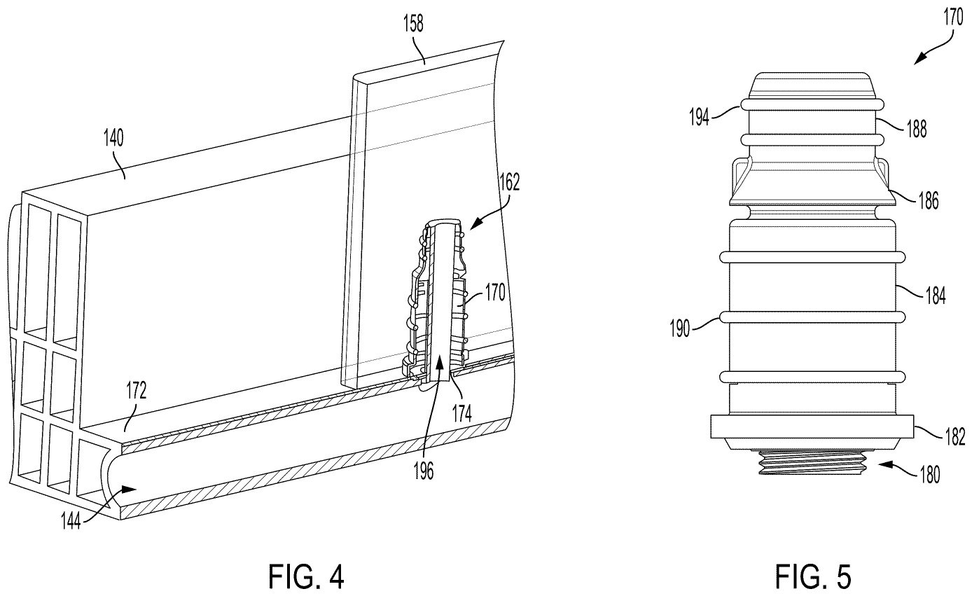

With reference now to FIGS. 3-5, the cooling/mounting connectors 170 will be described in more detail. In general, the connectors 170 are configured to provide: (i) a quick-connect for easy attachment of the battery modules 146 to the battery pack assembly side supports 140, (ii) seals for the battery modules 146 to reduce NVH and leakage, and (iii) a fluid connection to enable coolant flow into and out of the battery modules 146. As shown in FIGS. 3 and 4, the connectors 170 are configured to couple to a support surface 172 of the side support 140, and fluidly connect to the coolant passage 144 via a port 174 formed through the support surface 172. In the example embodiment, the connectors 170 are threadably connected to the support surface 172. However, it will be appreciated that connectors 170 may be coupled to the side supports 140 by any suitable method such as, for example, welding, adhesives, etc.

As shown in FIGS. 2 and 3, in the example embodiment, the connectors 170 on one side support 140 are configured as fluid inlets into the battery module 146, while the connectors 170 on the other side support 140 are configured as fluid outlets out of the battery module 146. As shown in FIG. 3, vehicle 100 may include a coolant circuit or system 164 having a pump 166 configured to supply a flow of coolant to the coolant passage 144 of the first side support 140, through the inlet connectors 170 and into the battery module 146. The coolant travels from one end plate 158 to the opposite end plate 158 while absorbing thermal energy generated by the battery cells 130. The heated coolant is then supplied through the outlet connectors 170 and into the coolant passage 144 of the second side support 140. The heated coolant is then cooled, for example via a heat exchanger 168, and returned to pump 166 to repeat the cycle.

As shown in FIG. 5, in the example implementation, each cooling/mounting connector 170 generally includes a connecting portion 180, a base support 182, a first cylindrical portion 184, a frustoconical portion 186, and a second cylindrical portion 188. The connecting portion 180 is threaded and is configured to threadably secure to the coolant port 174 formed in the side support 140. The base support 182 is generally annular and is configured to seat against the support surface 172. The first cylindrical portion 184 extends upwardly from the base support 182 and includes one or more seals 190 (e.g., O-rings) configured to seal against the receiving port 162 of the battery module end plate 158. The frustoconical portion 186 is disposed between the first and second cylindrical portions 184, 188 and tapers inwardly as it extends from the first cylindrical portion 184 to the second cylindrical portion 188. The second cylindrical portion 188 extends upwardly from the frustoconical portion 186 and includes one or more seals 194 (e.g., O-rings) configured to seal against the receiving port 162. As shown in FIG. 4, a coolant passage 196 extends through the connector 170 to direct coolant from the coolant passage 144 to the battery module 146, or from the battery module 146 to the coolant passage 144.

In the example embodiment, the second cylindrical portion 188 has a smaller diameter than the first cylindrical portion 184 to facilitate locating of the connector 170 within the receiving port 162. The frustoconical portion 186 facilitates proper seating of the end plate 158 over the connectors 170 by guiding a misaligned receiving port 162 about the first cylindrical portion 184. Moreover, the connector 170 provides NVH absorption for the battery module 146 through the seals 190, 194.

As shown in FIG. 6, the battery module end plate 158 includes at least one receiving port 162 configured to fit over and receive connector 170. The receiving port 162 has a complimentary size and shape to that of the connector 170 to provide an interference fit for a fluid-tight seal with the connector 170 and its seals 190, 194. The receiving port 162 is fluidly connected to a conical or tapering passage 200, which is fluidly connected to a supply/outlet passage 202, which is in turn connected to an interior 204 of the battery module 146. In this way, coolant from the coolant passage 144 passes through connector coolant passage 196 and into the tapering passage 200 and supply/outlet passage 202. The coolant is then supplied into the battery module interior 204 for cooling of the battery cells 130. In the example embodiment, the coolant flows freely through the module interior 204 and immerses the battery cells 130 for cooling thereof. In alternative arrangements, the supply/outlet passage 202 may be fluidly coupled to additional conduits and/or cold plates for indirect heat exchange with the battery cells 130 (rather than direct cooling via immersion). The heated coolant then passes through the opposite outlet passage 202, connector coolant passage 196, and coolant passage 144. The heated coolant is then cooled (e.g., via radiator, heat exchanger 168, etc.) and returned to the opposite coolant passage 144 to repeat the cycle.

It will be appreciated that the terms “controller” or “control system” or “module” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A battery module for a battery pack assembly of an electric vehicle, the battery module comprising:
a housing having an interior configured to house a plurality of battery cells; and
first and second opposed end plates each having a receiving aperture fluidly coupled to the housing interior and configured to fit over and receive a cooling/mounting connector of the battery pack assembly to facilitate a quick-connect coupling to the battery pack assembly,
wherein the first end plate receiving aperture is configured to receive a flow of coolant from a coolant passage in a first cooling/mounting connector and provide the coolant flow to the housing interior for cooling of the plurality of battery cells, and
wherein the second end plate receiving aperture is configured to receive the flow of coolant from the housing interior and provide the flow of coolant to a coolant passage in a second cooling/mounting connector.

2. The battery module of claim 1, wherein the battery module is coupled to the battery pack assembly via the first and second cooling/mounting connectors such that the battery module does not require any fasteners to further secure the battery module to the battery pack assembly.

3. The battery module of claim 1, wherein the receiving aperture has a complimentary size and shape to the cooling/mounting connector to provide an interference fit between the first or second end plate and the cooling/mounting connector.

4. The battery module of claim 1, wherein coolant supplied to the housing interior immerses the plurality of battery cells for cooling thereof.

5. The battery module of claim 1, wherein each of the first and second end plates further includes a tapering aperture configured to receive or supply the flow of coolant from or to the cooling/mounting connector.

6. The battery module of claim 5, wherein each of the first and second end plates further includes a supply/outlet passage fluidly coupled between the tapering aperture and the housing interior to supply the flow of coolant therebetween.

7. The battery module of claim 1, wherein the first end plate comprises a set of two receiving apertures configured to each receive one cooling/mounting connector.

8. The battery module of claim 7, wherein the second end plate comprises a set of two receiving apertures configured to each receive one cooling/mounting connector.

9. The battery module of claim 1, wherein the housing comprises a bottom wall, opposed sidewalls, a top cover, and the end plates to define the housing interior.

10. The battery module of claim 1, wherein at least one of the first and second end plates includes electric terminals.

11. An electrified vehicle, comprising:
an electric traction motor; and
a high voltage battery system configured to power the electric traction motor and including a high voltage battery pack assembly with at least one battery module, comprising:
a housing having an interior configured to house a plurality of battery cells; and
first and second opposed end plates each having a receiving aperture fluidly coupled to the housing interior and configured to fit over and receive a cooling/mounting connector of the battery pack assembly to facilitate a quick-connect coupling to the battery pack assembly,
wherein the first end plate receiving aperture is configured to receive a flow of coolant from a coolant passage in a first cooling/mounting connector and provide the coolant flow to the housing interior for cooling of the plurality of battery cells, and
wherein the second end plate receiving aperture is configured to receive the flow of coolant from the housing interior and provide the flow of coolant to a coolant passage in a second cooling/mounting connector.

12. The electrified vehicle of claim 11, wherein the battery module is coupled to the battery pack assembly via the first and second cooling/mounting connectors such that the battery module does not require any fasteners to further secure the battery module to the battery pack assembly.

13. The electrified vehicle of claim 11, wherein the receiving aperture has a complimentary size and shape to the cooling/mounting connector to provide an interference fit between the first or second end plate and the cooling/mounting connector.

14. The electrified vehicle of claim 11, wherein coolant supplied to the housing interior immerses the plurality of battery cells for cooling thereof.

15. The electrified vehicle of claim 11, wherein each of the first and second end plates further includes a tapering aperture configured to receive or supply the flow of coolant from or to the cooling/mounting connector.

16. The electrified vehicle of claim 15, wherein each of the first and second end plates further includes a supply/outlet passage fluidly coupled between the tapering aperture and the housing interior to supply the flow of coolant therebetween.

17. The electrified vehicle of claim 11, wherein the first end plate comprises a set of two receiving apertures configured to each receive one cooling/mounting connector.

18. The electrified vehicle of claim 17, wherein the second end plate comprises a set of two receiving apertures configured to each receive one cooling/mounting connector.

19. The electrified vehicle of claim 11, wherein the housing comprises a bottom wall, opposed sidewalls, a top cover, and the end plates to define the housing interior.

20. The electrified vehicle of claim 11, wherein at least one of the first and second end plates includes electric terminals.
